(19) United States
(12) Patent Application Publication
(10) Pub. No.: US 2026/0322211 A1
(43) Pub. Date: Oct. 15, 2026

(54) DRIVE BRAKE UNIT AND VEHICLE

(71) Applicant: AUMOVIO Germany GmbH, Frankfurt am Main (DE)

(72) Inventors: Paul Linhoff, Neu-Anspach (DE); Peter Schack, Seligenstadt (DE)

(73) Assignee: AUMOVIO Germany GmbH, Frankfurt am Main (DE)

(21) Appl. No.: 19/644,958

(22) Filed: Apr. 10, 2026

(30) Foreign Application Priority Data
Apr. 11, 2025 (DE) 10 2025 114 311.0

(51) Int. Cl. H02K 7/102; F16D 65/853; H02K 7/00; H02K 9/19; H02K 16/02; H02K 21/14

(52) U.S. Cl. CPC H02K 7/102; F16D 65/853; H02K 7/006; H02K 9/19; H02K 16/02; H02K 21/145

(57) ABSTRACT

A drive brake unit for a vehicle comprises a wheel-integrated electric motor and a friction brake unit. The electric motor comprises a drive rotor and a drive stator. The friction brake unit comprises a rotatable friction partner and at least one non-rotatable friction partner, wherein at least one non-rotatable friction partner is arranged so as to be displaceable against the rotatable friction partner by a brake actuator and has at least one cooling channel for conducting a cooling liquid. The angular velocity of the rotatable friction partner is invariably coupled to the angular velocity of the drive rotor.

### TECHNICAL FIELD

The present embodiments relate to a vehicle and a drive brake unit for the vehicle, having a wheel-integrated electric motor for driving the vehicle and a friction brake unit for generating vehicle deceleration.

### BACKGROUND

A drive brake unit of said type is known for example from DE 10 2019 120 409 A1. However, the drive brake unit proposed there is, for a number of reasons, insufficiently suitable for most vehicle applications, and in particular for use in steered passenger car front wheels. As the solution is space-intensive, not very efficient, and has a complex actuator system.

### SUMMARY

It is therefore an object to provide a drive brake unit which reduces or overcomes at least some of the above-stated disadvantages.

Thus, in a drive brake unit mentioned at the outset, the angular velocity of the rotatable friction partner is invariably coupled to the angular velocity of the drive rotor. Thus, for example, there is no transmission arranged between the drive rotor of the electric motor and the rotatable friction partner. In this way, the drive brake unit gains considerably in structural space and efficiency (no transmission losses), but in many applications requires a considerably more powerful electric motor. As a result of advances in the production technology of electric motors in recent years, the latter is now possible in a way that saves installation space and involves lower production outlay. At the same time, the friction brake unit can also be shifted to a greater extent into the interior of the drive brake unit, whereby more installation space is freed up in the region of the wheel suspension, and the drive brake unit can also be used for a wide variety of passenger cars or utility vehicle applications, for example in a steered front-wheel application of a vehicle.

A drive stator may be understood to mean that part of the stator which actively contributes to the drive, that is to say, for example a winding section and an associated winding support. Accordingly, a drive rotor should be understood to mean that part of the rotor which actively contributes to the drive and, for example, carries permanent magnets, such as an inner rotor and/or an outer rotor.

In this document, "axial" or "axial direction" are to be understood as meaning the direction parallel to the electric motor rotation axis and "radial" or "radial direction" are to be understood as meaning the direction or directions perpendicular to said electric motor rotation axis. Here, owing to the transmission less arrangement as a direct drive, the electric motor rotation axis also corresponds to the axis of rotation of the wheel. In the present document, a drive brake unit is to be understood to mean a combination of a wheel-integrated friction brake unit and a wheel-integrated electric motor (or wheel hub motor).

The cooling channel (each cooling channel) of the non-rotatable friction partner may comprise exactly one inflow and exactly one outflow.

The friction brake unit may comprise at least two non-rotatable friction partners, wherein the rotatable friction partner is arranged between the two non-rotatable friction partners along an electric motor rotation axis. At least the rotatable friction partner is in this case may be formed as an annular disk rotating about the electric motor rotation axis. However, it is also possible for the rotatable friction partner and both non-rotatable friction partners to each be (substantially) formed as an annular disk rotating about the electric motor rotation axis. As a result, the effective friction area and maximum braking force may become large, even with a relatively small friction brake unit (e.g. in comparison with a commercially available disk brake with brake caliper). The active cooling by means of the at least one cooling channel makes possible the particularly compact design with high braking power.

For example, at least two non-rotatable friction partners each have at least one cooling channel for conducting a cooling liquid. It is thereby possible to achieve more uniform cooling of the friction brake unit and thus a higher maximum braking power.

In one embodiment, a first non-rotatable friction partner is arranged so as to be displaceable parallel to the electric motor rotation axis by the brake actuator and a second non-rotatable friction partner is arranged in a fixed manner parallel to the electric motor rotation axis. The friction brake unit can thus be designed, for example, as a fixed-caliper brake or as a multi-disk brake with at least one fixed brake disk.

For example, the second non-rotatable friction partner is connected to a supporting element, wherein the supporting element is configured for supporting and attachment to a motor housing and/or a wheel bearing and/or a vehicle interface, and wherein the supporting element is also configured as a guide element for the first non-rotatable friction partner during a movement parallel to the electric motor rotation axis. The supporting element can for this purpose have a substantially cylindrical shell-shaped section, on the radial outer side or radial inner side of which the first non-rotatable friction partner is displaceable arranged.

In one embodiment, the rotatable friction partner is connected via a brake rotor carrier to a drive rotor carrier of the drive rotor and/or to a wheel bearing. The brake rotor carrier may for example also be fastened to the wheel bearing by means of common fastening means with the drive rotor carrier. Although a separate brake rotor carrier increases the weight in comparison with direct attachment of the rotatable friction partner to the drive rotor, it minimizes adverse effects on the electric motor. The brake rotor carrier is provided as an independent component and not a constituent part of the drive rotor or of the drive rotor carrier.

The rotatable friction partner is preferably fastened on a radial inner side of the brake rotor carrier. By means of this configuration, the brake rotor carrier can also assume the function of a heat shield between the friction partners and the drive rotor. This protects the sensitive permanent magnets in the event of emergency braking or downhill descent, in addition to the active liquid cooling via the cooling channel or the cooling channels.

In an alternative embodiment, the rotatable friction partner is fastened to a radial inner side of the drive rotor.

It is for example for the at least two cooling channels to split up from a common brake cooling inflow and to flow together (at the end of the cooling channels) in a common brake cooling outflow.

It is for example if the drive brake unit has exactly one wheel cooling inflow for inflowing cooling liquid and exactly one wheel cooling outflow for outflowing cooling liquid, wherein the wheel cooling inflow splits downstream into a brake cooling inflow for one or more cooling channels of the friction brake unit and an engine cooling inflow to an engine cooling channel of the electric motor. By virtue of the fact that the cooling channels of the friction brake unit and the engine cooling channel are arranged in parallel and not in series, the pressure drop is reduced, and the associated delivery pump in the vehicle can be of smaller dimensions.

In one embodiment, an engine cooling outflow at the end of the engine cooling channel and a common brake cooling outflow at the end of the at least one cooling channel of the brake unit are brought together via the common wheel cooling outflow.

For example, the at least one cooling channel of the non-rotatable friction partner comprises at least two inflows and at least two outflows, wherein the inflows and the outflows are arranged offset along the non-rotatable friction partner in the rotational direction about the electric motor rotation axis. It is also possible that a plurality of cooling channels or cooling channel sections which have their own inflows and outflows are arranged in one or both non-rotatable friction partners. By means of a higher number of inflows and outflows or cooling channels/cooling channel sections in a single non-rotatable friction partner, the temperature differences along the non-rotatable friction partner can be reduced, for example in the case of a hot-running friction brake unit. This may the case when the one or both non-rotatable friction partners are rotating clamping disks.

For example, the inflows of the cooling channel are distributed substantially uniformly along the non-rotatable friction partner in the rotational direction and/or the outflows of the cooling channel are distributed substantially uniformly along the non-rotatable friction partner in the rotational direction. For example, an inflow, an outflow, an inflow and an outflow can be arranged in each case alternately at intervals of approximately 90° in the rotational direction about the electric motor rotation axis.

One or more inflows of the cooling channel of the non-rotatable friction partner are may be on a radial inner side of the cooling channel or on a radial outer side of the cooling channel.

One or more outflows of the cooling channel of the non-rotatable friction partner may be arranged on a radial inner side of the cooling channel or on a radial outer side of the cooling channel.

For example, the rotatable friction partner is arranged in a reversibly displaceable manner parallel to an electric motor rotation axis. The rotatable friction partner can thus be formed as a floating brake disk, for example, which is arranged so as to be shiftable/displaceable in the axial direction to a certain extent.

In one embodiment, the rotatable friction partner is arranged displaceably by means of the brake rotor carrier, such that, by means of the brake actuator, a first non-rotatable friction partner can initially be displaced parallel to the electric motor rotation axis against the rotatable friction partner, wherein, by further displacement of the first non-rotatable friction partner, the rotatable friction partner can be displaced against a second non-rotatable friction partner in order to generate a braking torque.

At least one non-rotatable friction partner may be formed as a clamping disk rotating about the electric motor rotation axis, for example wherein two non-rotatable friction partners are designed as clamping disks rotating about an electric motor rotation axis. In this case, the second non-rotatable friction partner can be part of a component composed of clamping disk and supporting element.

In one embodiment, at least one rotating clamping disk has a base body and at least one friction element connected to the base body, wherein the cooling channel is arranged in the base body. The base body may for example be made of cast iron. The base body of the second non-rotatable friction partner and the supporting element may be produced as a one-piece component (for example from cast iron). Cast iron has a high heat capacity together with good mechanical stability and is therefore extremely suitable for the present application. The friction element or the friction elements can be manufactured, for example, from a steel.

The rotatable friction partner may be formed as a solid lining disk rotating about an electric motor rotation axis. For example when two non-rotatable friction partners are present in the form of clamping disks.

The rotatable friction partner may comprise a base disk rotating about an electric motor rotation axis, wherein at least one brake lining element is arranged on an axial end face of the base disk, with for example in each case at least one brake lining element being arranged on both axial end faces of the base disk.

In one embodiment, the electric motor is a double-rotor radial flux motor in which the drive stator comprises a winding section arranged in a radial direction between an outer rotor having permanent magnets and an inner rotor having permanent magnets. Such electric motors may be suitable in conjunction with the present friction brake unit, since they have a very high power density and torque density and can therefore readily be configured as a direct drive without a transmission even for a passenger car application.

For example, the friction brake unit is arranged radially within, and axially substantially at the same height as the drive stator and/or the drive rotor and/or an outer rotor having permanent magnets and/or an inner rotor having permanent magnets. By dispensing with a wheel-integrated transmission and the active brake cooling provided, such a structural space efficient arrangement is possible and allows the integration of the drive brake unit into existing wheel suspension concepts, even on steered front wheels of a passenger car.

The object is also achieved by a vehicle comprising at least one drive brake unit as described herein. In an embodiment, the vehicle comprises a drive brake unit of this kind at each of the two vehicle front wheels. Since the drive brake unit can provide both a high maximum regenerative braking torque and a high maximum friction braking torque, it is suitable for use in front wheels. In the case of an ideal distribution of braking force, the front wheels must in most driving situations provide a higher braking force than the rear wheels in order to ensure optimum vehicle stability.

### BRIEF DESCRIPTION OF THE DRAWINGS

In the drawings:

FIG. 1 shows an isometric partial sectional view of an embodiment of a drive brake unit,

FIG. 2 shows a partial sectional view of the embodiment of FIG. 1 with the friction brake unit in a more detailed view,

FIG. 3 shows a schematic sectional view of a non-rotatable friction partner in a first embodiment along the section line A-A in FIG. 2, and

FIG. 4 shows a schematic sectional view of a non-rotatable friction partner in a second embodiment along the section line A-A in FIG. 2.

### DETAILED DESCRIPTION

In the following detailed description of embodiments, identical reference numerals denote substantially same or identical parts in or on these embodiments. To better illustrate the invention, the preferred embodiments illustrated in the figures are however not always illustrated to scale.

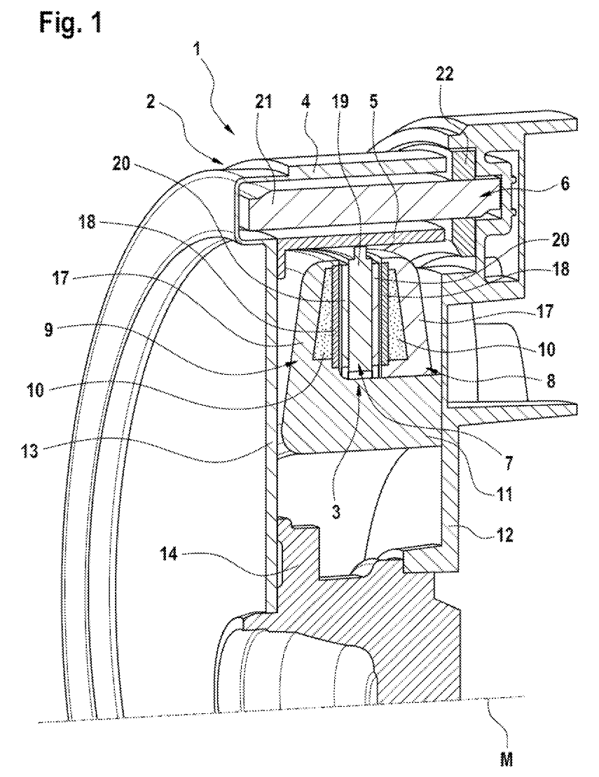

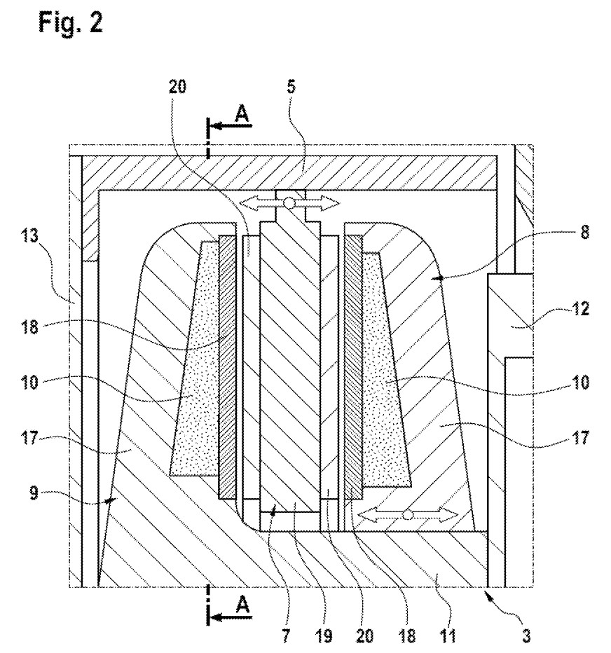

FIG. 1 and 2 show an embodiment of a drive brake unit 1 comprising a wheel-integrated electric motor 2 for driving a vehicle and a friction brake unit 3 arranged in an axially overlapping manner with the electric motor 2. For the sake of clarity, components of the drive brake unit 1 that are not essential for the explanation of the embodiments, such as the brake actuator, are not illustrated in the figures.

As can be seen in FIG. 1, the electric motor 2 comprises a drive rotor 4, 5 and a drive stator 6. The drive rotor 4, 5 and the drive stator 6 are configured to interact by means of interacting magnetic fields in order to generate a drive torque.

FIG. 1 and 2 show that the friction brake unit 3 comprises a rotatable friction partner 7 and two non-rotatable friction partners 8, 9. A non-rotatable friction partner 8 is arranged so as to be displaceable against the rotatable friction partner 7 by a brake actuator (not illustrated). The rotatable friction partner 7 is arranged between the two non-rotatable friction partners 8, 9 along an electric motor rotation axis M. The angular velocity of the rotatable friction partner 7 is invariably coupled to the angular velocity of the drive rotor 4, 5.

A first non-rotatable friction partner 8 is arranged so as to be displaceable by the brake actuator parallel to the electric motor rotation axis M. A second, non-rotatable friction partner 9 is arranged in a fixed manner parallel to the electric motor rotation axis M. The second non-rotatable friction partner 9 is connected to a supporting element 11. The supporting element 11 is configured for supporting and attachment to a motor housing 12. The supporting element 11 also serves as a guide element for the first non-rotatable friction partner 8 during a movement parallel to the electric motor rotation axis M. Here, the motor housing 12 comprises a (substantially radially running) stator plate as stator support for the drive stator 6.

The rotatable friction partner 7 is arranged in such a way that it can be displaced in a reversible manner parallel to the electric motor rotation axis M. This may be achieved by means of an axially movable fastening to the drive rotor 5 or to a brake rotor carrier. The rotatable friction partner 7 can be arranged in a displaceable manner by means of the brake rotor carrier/drive rotor 5, so that the first non-rotatable friction partner 8 can be displaced against the rotatable friction partner 7 initially parallel to the electric motor rotation axis M by means of the brake actuator. By further displacement of the first non-rotatable friction partner 8, the rotatable friction partner 7 can then be displaced against the second non-rotatable friction partner 9 in order to generate a braking torque.

The non-rotatable friction partners 8, 9 are in this case formed as clamping disks rotating about the electric motor rotation axis M. In contrast to a brake caliper, this results in a friction surface between the rotatable friction partner 7 and the non-rotatable friction partners 8, 9 that is multiple times greater.

The rotatable friction partner 7 comprises a base disk 19 rotating about an electric motor rotation axis M. In each case at least one brake lining element 20 is arranged on both axial end sides of the base disk 19. Alternatively, the rotatable friction partner 7 can be formed as a solid lining disk rotating about an electric motor rotation axis M.

The rotating clamping disks of the non-rotatable friction partners 8, 9 each comprise a base body 17 and at least one friction element 18 connected to the base body 17. The non-rotatable friction partners 8, 9 each have at least one cooling channel 10 for conducting a cooling liquid. The cooling channel 10 is arranged in each case in the base body 17.

Here, the rotatable friction partner 7 is fastened (in axially displaceable fashion) to a radial inner side of the drive rotor 5. In the present case, the electric motor 2 is a double-rotor radial flux motor. The drive stator 6 is arranged in a radial direction between an outer rotor 4 having permanent magnets and an inner rotor 5 having permanent magnets. A drive rotor carrier 14 connects the drive rotor 4, 5 or the outer rotor 4 and inner rotor 5 to a rotatable section of a wheel bearing 14. The wheel bearing 14 is illustrated here in simplified form as one piece, but must comprise a rotatable section and a non-rotatable section. The drive stator 6 comprises a winding section 21 which is supported by a winding carrier 22. The drive stator 6 is fastened to the motor housing 12. The motor housing 12 is in turn connected to a non-rotatable section of the wheel bearing 14.

The friction brake unit 3 is arranged radially within, and axially substantially at the same height as the drive stator 6, the outer rotor 4 and the inner rotor 5.

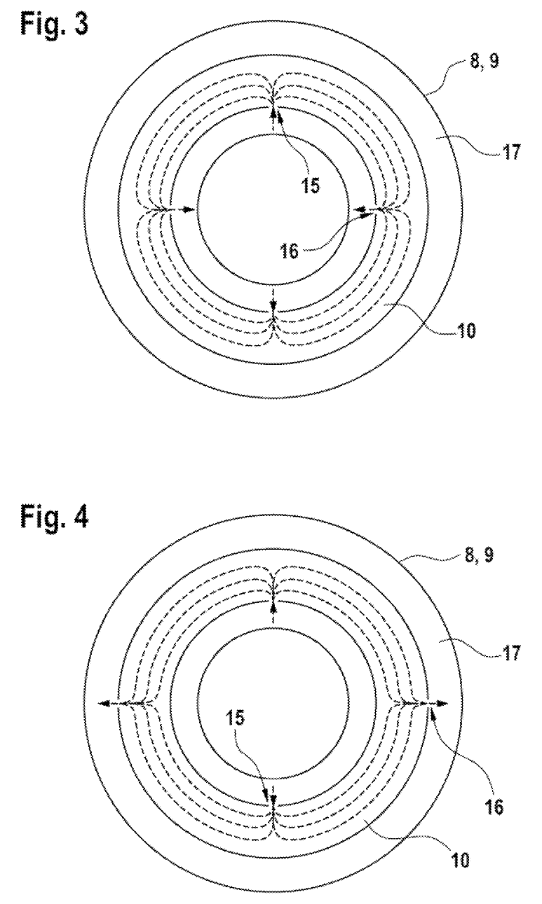

FIGS. 3 and 4 illustrate two schematic alternatives for the configuration of the cooling channels 10 in the non-rotatable friction partner 8, 9, for example corresponding to the section along the plane A-A shown in FIG. 2. The at least two cooling channels 10 in the basic bodies 17 may split from a common brake cooling inflow and flow together into a common brake cooling outflow. The exact further path of the cooling channels 10 in the basic bodies 17 outside the rotating cooling channels 10 is not illustrated.

As shown in FIGS. 3 and 4, each cooling channel 10 of a non-rotatable friction partner 8, 9 can comprise two or more inflows 15 and two or more outflows 16. These figures show schematic flow paths of the coolant through the cooling channels 10 with dashed lines. Here, the inflows 15 and the outflows 16 are arranged offset by in each case 180° in the rotational direction about the electric motor rotation axis along the non-rotatable friction partner 8, 9.

In FIG. 3, all the inflows 15 and all the outflows 16 are arranged on a radial inner side of the cooling channel 10.

In FIG. 4, all the inflows 15 are arranged on a radial inner side of the cooling channel 10. All of the outlets 16 are arranged on a radial outer side of the cooling channel 10.

1. A drive brake unit for a vehicle comprising:
a wheel-integrated electric motor for driving the vehicle;
a friction brake unit for generating vehicle deceleration;
a drive rotor and a drive stator for the electric motor, wherein the drive rotor and the drive stator are configured to interact in order to generate a drive torque by interacting magnetic fields;
a rotatable friction partner for the friction brake unit and at least one non-rotatable friction partner;
at least one non-rotatable friction partner displaceable against the rotatable friction partner by a brake actuator; and
at least one cooling channel for the non-rotatable friction partner conducting a cooling liquid;
wherein the angular velocity of the rotatable friction partner is invariably coupled to the angular velocity of the drive rotor.

2. The drive brake unit as claimed in claim 1, wherein the friction brake unit comprises at least two non-rotatable friction partners, wherein the rotatable friction partner is arranged between the two non-rotatable friction partners along an electric motor rotation axis.

3. The drive brake unit as claimed in claim 2, wherein at least two non-rotatable friction partners each have at least one cooling channel for conducting a cooling liquid.

4. The drive brake unit as claimed in claim 2, wherein a first non-rotatable friction partner is displaceable by the brake actuator parallel to the electric motor rotation axis and a second non-rotatable friction partner is arranged in a fixed manner parallel to the electric motor rotation axis.

5. The drive brake unit as claimed in claim 4, wherein the second non-rotatable friction partner is connected to a supporting element, wherein the supporting element is configured for supporting and attachment to at least one of a motor housing, a wheel bearing, and a vehicle interface, and wherein the supporting element is also configured as a guide element for the first non-rotatable friction partner during a movement parallel to the electric motor rotation axis.

6. The drive brake unit as claimed in claim 1, wherein the rotatable friction partner is connected via a brake rotor carrier to at least one of a drive rotor carrier of the drive rotor and to a wheel bearing.

7. The drive brake unit as claimed in claim 6, wherein the rotatable friction partner is fastened to a radial inner side of the brake rotor carrier.

8. The drive brake unit as claimed in claim 1, wherein the rotatable friction partner is fastened to a radial inner side of the drive rotor.

9. The drive brake unit as claimed in claim 1, wherein the at least two cooling channels split from a common brake cooling inflow and flow together in a common brake cooling outflow.

10. The drive brake unit as claimed in claim 1, wherein the drive brake unit comprises exactly one wheel cooling inflow for inflowing cooling liquid and exactly one wheel cooling outflow for outflowing cooling liquid, wherein the wheel cooling inflow downstream splits into a brake cooling inflow for one or more cooling channels of the friction brake unit and an engine cooling inflow to an engine cooling channel of the electric motor.

11. The drive brake unit as claimed in claim 10, wherein an engine cooling outflow at the end of the engine cooling channel and a common brake cooling outflow at the end of the at least one cooling channel of the brake unit are brought together via the common wheel cooling outflow.

12. The drive brake unit as claimed in claim 1, wherein the at least one cooling channel of the non-rotatable friction partner comprises at least two inflows and at least two outflows, wherein the inflows and the outflows are arranged offset along the non-rotatable friction partner in a rotational direction about the electric motor rotation axis.

13. The drive brake unit as claimed in claim 12, wherein at least one of the inflows of the cooling channel are distributed uniformly along the non-rotatable friction partner in the rotational direction and the outflows of the cooling channel are distributed uniformly along the non-rotatable friction partner in the rotational direction.

14. The drive brake unit as claimed in claim 1, wherein at least one inflow of the cooling channel of the non-rotatable friction partner are arranged on a radial inner side of the cooling channel or are arranged on a radial outer side of the cooling channel.

15. The drive brake unit as claimed in claim 1, wherein one or more outflows of the cooling channel of the non-rotatable friction partner are arranged on a radial inner side of the cooling channel or on a radial outer side of the cooling channel.

16. The drive brake unit as claimed in claim 1, wherein the rotatable friction partner is reversibly displaceable parallel to an electric motor rotation axis.

17. The drive brake unit as claimed in claim 16, wherein the rotatable friction partner is arranged displaceably by the brake rotor carrier, such that, by the brake actuator a first non-rotatable friction partner can initially be displaced parallel to the electric motor rotation axis against the rotatable friction partner, wherein, by further displacement of the first non-rotatable friction partner, the rotatable friction partner can be displaced against a second non-rotatable friction partner in order to generate a braking torque.

18. The drive brake unit as claimed in claim 1, wherein at least one non-rotatable friction partner is formed as a clamping disk rotating about the electric motor rotation axis.

19. The drive brake unit as claimed in claim 18, wherein at least one rotating clamping disk has a base body and at least one friction element connected to the base body, wherein the cooling channel is arranged in the base body.

20. The drive brake unit as claimed in claim 1, wherein the rotatable friction partner is formed as a solid lining disk rotating about an electric motor rotation axis.

21. The drive brake unit as claimed in claim 1, wherein the rotatable friction partner comprises a base disk rotating about an electric motor rotation axis, wherein at least one brake lining element is arranged on an axial end side of the base disk.

22. The drive brake unit as claimed in claim 1, wherein the electric motor is a double-rotor radial flux motor in which the drive stator comprises a winding section arranged in a radial direction between an outer rotor having permanent magnets and an inner rotor having permanent magnets.

23. The drive brake unit as claimed in claim 1, wherein the friction brake unit is arranged radially inwardly and at least one of: axially at the same height as the drive stator, axially at the same height as the drive rotor, an outer rotor having permanent magnets, and an inner rotor having permanent magnets.

24. A vehicle comprising:
at least one drive brake unit;
a wheel-integrated electric motor for driving the vehicle;
a friction brake unit for generating vehicle deceleration;
a drive rotor and a drive stator for the electric motor, wherein the drive rotor and the drive stator are configured to interact in order to generate a drive torque by interacting magnetic fields;
a rotatable friction partner for the friction brake unit and at least one non-rotatable friction partner;
at least one non-rotatable friction partner displaceable against the rotatable friction partner by a brake actuator; and
at least one cooling channel for the non-rotatable friction partner conducting a cooling liquid;
wherein the angular velocity of the rotatable friction partner is invariably coupled to the angular velocity of the drive rotor.

25. The vehicle as claimed in claim 24 wherein, the at least one drive brake unit is a drive brake unit on each of two front wheels of the vehicle.
